(19) United States
(12) Patent Application Publication
(10) Pub. No.: US 2010/0271701 A1
(43) Pub. Date: Oct. 28, 2010

(54) Hybrid Lens And Method Of Manufacturing The Same

(76) Inventors: Yuan-Lin Lee, Hemei Jen (TW); Wei Shen, Hemei Jen (TW); Yu-Chien Yang, Hemei Jen (TW)

Correspondence Address: LIN & ASSOCIATES INTELLECTUAL PROPERTY, INC., P.O. BOX 2339, SARATOGA, CA, 95070-0339, US

(21) Appl. No.: 12/430,051

(22) Filed: Apr. 24, 2009

(51) Int. Cl. G02B 1/10; B29D 11/00

(52) U.S. Cl. 359/581; 264/1.7; 264/1.38

(57) ABSTRACT

A hybrid lens includes a lens substrate made of glass material, and a plastic layer formed and coating round the lens substrate. An appropriate portion of the outer surfaces of the plastic layer is defined as a datum face. A method of manufacturing the foregoing hybrid lens is described hereinafter. Firstly, the lens substrate is fastened in a shaping cavity of a corresponding shaping mold with an appropriate portion of the inside of the shaping cavity defined as a shaping datum. Secondly, a predetermined amount of transparent plastic is poured into the shaping cavity. Next, the transparent plastic is hardened to form the plastic layer round the lens substrate, and accordingly, the datum face is formed on the plastic layer by means of the shaping datum. Lastly, the shaping mold is opened to obtain the hybrid lens.

### BACKGROUND OF THE INVENTION

1. Field of the Invention

The present invention generally relates to a lens technology, and more particularly to a hybrid lens and a method of manufacturing the hybrid lens.

2. The Related Art

With the development of microcircuitry and multimedia technology, digital cameras are now in widespread use. Many of portable electronic devices, such as mobile phones and the like, are now equipped with a digital camera. Optical lenses become a key element of the digital cameras. Conventionally, the lenses in the digital cameras are made of glass or plastic. However, single lenses made of either glass or plastic cannot meet the demands of both low cost and high image quality of digital cameras. Recently, so-called hybrid lenses have been developed to overcome the above problems, wherein the hybrid lens has a better performance than the plastic lens and a lower cost than the glass lens.

Referring to FIG. 1, a traditional hybrid lens 100′ includes a lens substrate 110′ made of glass material and a transparent plastic layer 120′ formed on an incidence surface or an emission surface of the lens substrate 110′. An appropriate outside of the lens substrate 110′ except the incidence surface and the emission surface is defined as a datum face 111′ for rightly assembling and positioning the hybrid lens 100′ in the digital camera. So the lens substrate 110′ must have an appearance of high-precision size. However, the glass material has high hardness and environmental tolerance characteristics that causes the difficulty in the production of high-precision appearance and further improves the production cost. Therefore, the hybrid lens 100′ having the datum face 111′ formed on the glass substrate 110′ usually has a poor yield and is difficult for the mass production thereof.

### SUMMARY OF THE INVENTION

An object of the present invention is to provide a hybrid lens adapted for being assembled in a digital product and a method of manufacturing the hybrid lens. The hybrid lens includes a lens substrate made of glass material, and a plastic layer formed and coating round the lens substrate. The plastic layer is made of transparent plastic material. An appropriate portion of the outer surfaces of the plastic layer is defined as a datum face capable of rightly assembling and positioning the hybrid lens in the digital product.

The method of manufacturing the above-mentioned hybrid lens is described hereinafter. Firstly, the lens substrate is fastened in a shaping cavity of a corresponding shaping mold, wherein an appropriate portion of the inside of the shaping cavity is defined as a shaping datum. Secondly, a predetermined amount of transparent plastic is poured into the shaping cavity. Next, the transparent plastic is hardened to form the plastic layer round the lens substrate, and accordingly, the datum face is formed on the plastic layer by means of the shaping datum. Lastly, the shaping mold is opened to obtain the hybrid lens.

As described above, the datum face of the hybrid lens of the present invention is directly formed on the plastic layer in the process of molding the plastic layer. Therefore, the hybrid lens having the datum face of the plastic material takes a relatively lower cost and further gains a good yield and a simple manufacture process so that can be mass produced.

### BRIEF DESCRIPTION OF THE DRAWINGS

The present invention will be apparent to those skilled in the art by reading the following description, with reference to the attached drawings, in which:

FIG. 1 is a cross-sectional view of a traditional hybrid lens;

FIG. 2 is a cross-sectional view of a hybrid lens according to a first embodiment of the present invention;

FIG. 3 is a cross-sectional view showing a method of manufacturing the hybrid lens of FIG. 2 in which a lens substrate of the hybrid lens is fastened in a corresponding mold assembly;

FIG. 4 is a cross-sectional view of a hybrid lens according to a second embodiment of the present invention;

FIG. 5 is a cross-sectional view showing a method of manufacturing a first plastic layer of the hybrid lens of FIG. 4 in which a lens substrate of the hybrid lens is fastened in a corresponding first shaping mold; and

FIG. 6 is a cross-sectional view showing a method of manufacturing a second plastic layer of the hybrid lens of FIG. 4 in which the lens substrate with the first plastic layer molded in FIG. 5 is fastened in a corresponding second shaping mold.

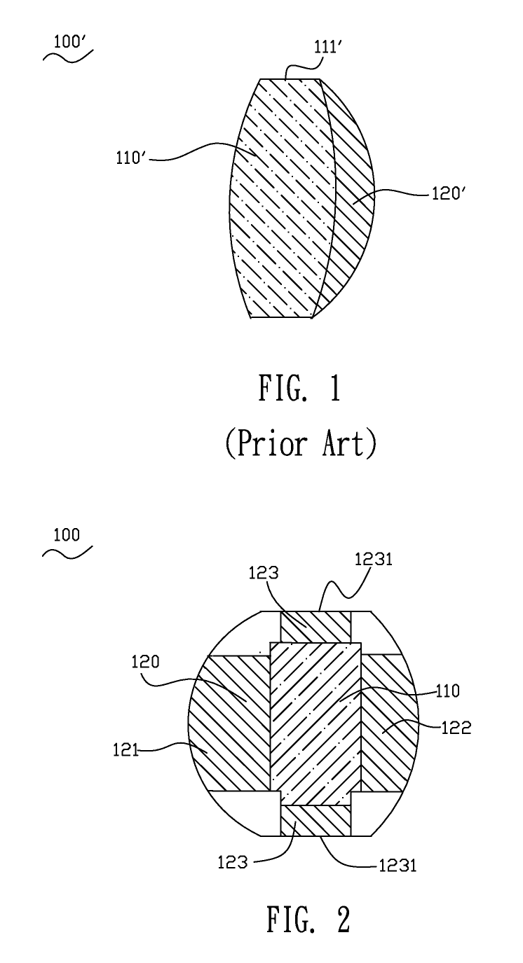

### DETAILED DESCRIPTION OF THE PREFERRED EMBODIMENT

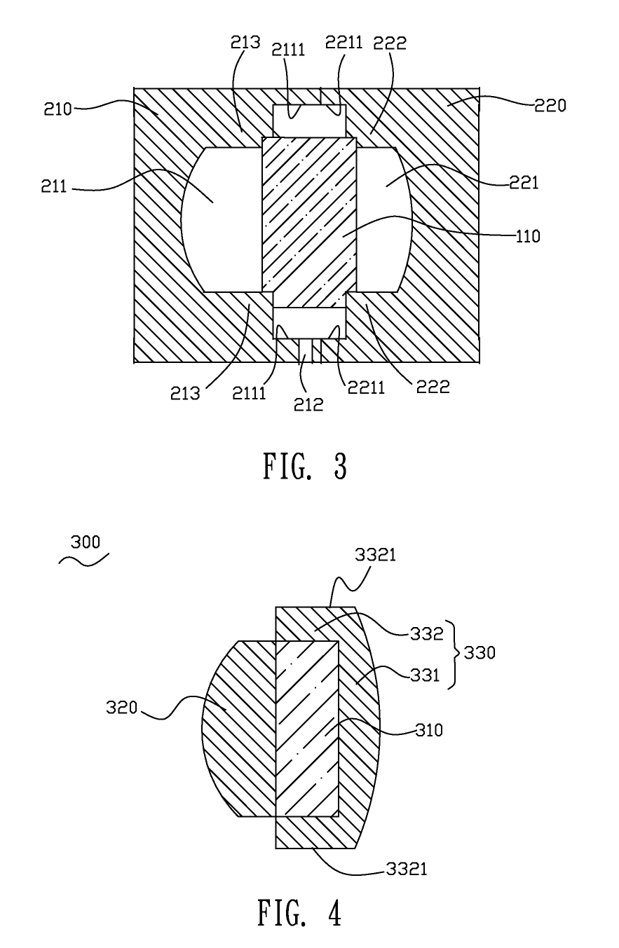

With reference to FIG. 2, a hybrid lens 100 according to a first embodiment of the present invention includes a lens substrate 110 made of glass material and a plastic layer 120 once molded round the lens substrate 110 by means of a corresponding mold assembly shown in FIG. 3. The plastic layer 120 includes a first coating portion 121 formed on an incidence surface of the lens substrate 110, a second coating portion 122 formed on an emission surface of the lens substrate 110, and a third coating portion 123 formed on the other outer surfaces of the lens substrate 110 except the incidence surface and the emission surface and connected between the first coating portion 121 and the second coating portion 122. The outer surface of the third coating portion 123 is defined as a datum face 1231 capable of rightly assembling and positioning the hybrid lens 100 in a digital camera (not shown).

Referring to FIG. 3, a method of manufacturing the above-mentioned hybrid lens 100 is carried by using the said mold assembly. The mold assembly includes a first shaping mold 210 and a second shaping mold 220 mated with the first shaping mold 210 to define a shaping chamber therebetween. The shaping chamber is composed of a first shaping cavity 211 formed on the first shaping mold 210 and a second shaping cavity 221 formed on the second shaping mold 220. The first shaping mold 210 further has an injection runner 212 passing therethrough and communicating with the first shaping cavity 211. A plurality of first fixing portions 213 are protruded into the first shaping cavity 211 from the inside of the first shaping cavity 211. An appropriate portion of the inside of the first shaping cavity 211 is defined as a first shaping datum 2111. A plurality of second fixing portions 222 are protruded into the second shaping cavity 221 from the inside of the second shaping cavity 221, and an appropriate portion of the inside of the second shaping cavity 221 is defined as a second shaping datum 2211.

Referring to FIG. 2 and FIG. 3 again, when the hybrid lens 100 is molded by the mold assembly, the lens substrate 110 is disposed in the shaping chamber and fastened by the fixing portions 213, 222. Then a predetermined amount of transparent thermosetting plastic is poured into the shaping chamber through the injection runner 212 and fills the shaping chamber for fully or partly coating the lens substrate 110. Next, the mold assembly is heated to make the thermosetting plastic hardened so as to form the plastic layer 120 round the lens substrate 110, and accordingly, the datum face 1231 is formed on the outer surface of the plastic layer 120 by means of the first shaping datum 2111 and the second shaping datum 2211. Lastly, the mold assembly is opened to make the first shaping mold 210 separated from the second shaping mold 220, such that the hybrid lens 100 shown in FIG. 2 is obtained.

With reference to FIG. 4, a hybrid lens 300 according to a second embodiment of the present invention includes a lens substrate 310 made of glass material, a first plastic layer 320 formed on an incidence surface of the lens substrate 310 and a second plastic layer 330. The second plastic layer 330 includes a first coating portion 331 formed on an emission surface of the lens substrate 310 and a second coating portion 332 formed on the other outer surfaces of the lens substrate 310 except the incidence surface and the emission surface. The second coating portion 332 is positioned between the first plastic layer 320 and the first coating portion 331, and connected with the first coating portion 331. The outer surface of the second coating portion 332 connected with the first coating portion 331 is defined as a datum face 3321 capable of rightly assembling and positioning the hybrid lens 300 in a digital camera (not shown).

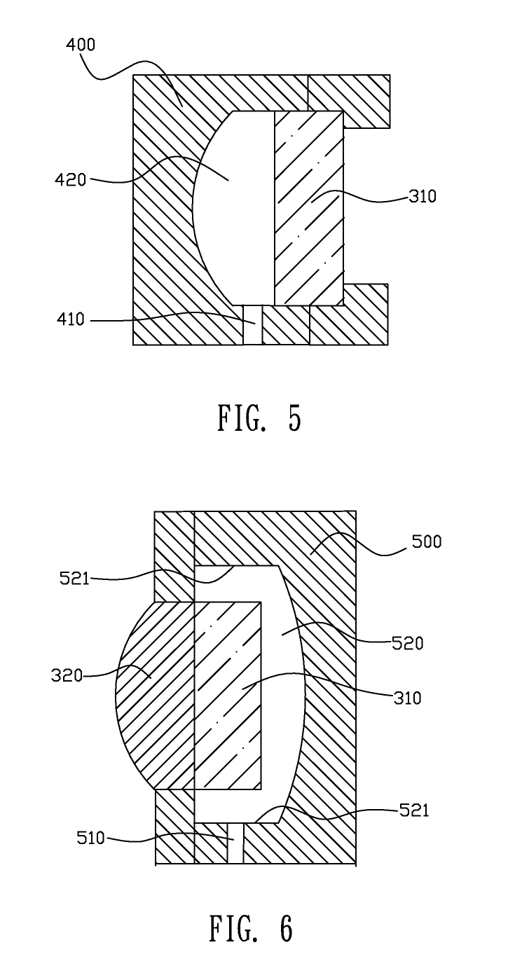

Referring to FIG. 5 and FIG. 6, a method of manufacturing the above-mentioned hybrid lens 300 is carried by using a first shaping mold 400 adapted for molding the first plastic layer 320, and a second shaping mold 500 adapted for molding the second plastic layer 330. The first shaping mold 400 has a first shaping cavity 420, one end of which is opened freely, and a first injection runner 410 passing therethrough and communicating with the first shaping cavity 420. The second shaping mold 500 has a second shaping cavity 520, one end of which is opened freely, and a second injection runner 510 passing therethrough and communicating with the second shaping cavity 520. An appropriate portion of the inside of the second shaping cavity 520 is defined as a shaping datum 521.

Referring to FIGS. 5 and 6 in conjunction with FIG. 4 again, when manufacturing the hybrid lens 300, the first plastic layer 320 is firstly molded in the first shaping mold 400, and then the second plastic layer 330 is molded by means of the second shaping mold 500. The molding method will be described in further detail as follows. Firstly, the lens substrate 310 is fastened at the opened end of the first shaping cavity 420 and the incidence surface thereof stretches into the first shaping cavity 420. After a predetermined amount of ultraviolet-curing plastic is poured into the first shaping cavity 420 through the first injection runner 410 and fills the first shaping cavity 420, the ultraviolet-curing plastic is irradiated with ultraviolet rays from the exposed side of the lens substrate 310 so as to be cured. Then the first shaping mold 400 is opened to obtain a semi-finished hybrid lens having the first plastic layer 320 formed on the incidence surface of the lens substrate 310. Next, the semi-finished hybrid lens is fastened at the opened end of the second shaping cavity 520 and the lens substrate 310 stretches into the second shaping cavity 520. After a predetermined amount of ultraviolet-curing plastic is poured into the second shaping cavity 520 through the second injection runner 510 and fills the second shaping cavity 520, the ultraviolet-curing plastic is irradiated with ultraviolet rays from the side of the first plastic layer 320 so as to be cured to form the second plastic layer 330 on the lens substrate 310. Accordingly, the datum face 3321 is formed on the outer surface of the second plastic layer 330 by means of the shaping datum 521. Lastly, the second shaping mold 500 is opened, such that the hybrid lens 300 shown in FIG. 4 is obtained.

As described above, the datum face 1231, 3321 of the hybrid lens 100, 300 of the present invention is directly formed on the plastic layer 120, 330 in the process of molding the plastic layer 120, 330. Therefore, the hybrid lens 100, 300 having the datum face 1231, 3321 of the plastic material takes a relatively lower cost and further gains a good yield and a simple manufacture process so that can be mass produced.

The foregoing description of the present invention has been presented for purposes of illustration and description. It is not intended to be exhaustive or to limit the invention to the precise form disclosed, and obviously many modifications and variations are possible in light of the above teaching. For example, the plastic layer of the hybrid lens may be formed to partly or fully coat the lens substrate. The incidence surface and the emission surface of the hybrid lens may be any one of or a combination of at least two selected from a plane, a spherical surface, an aspherical surface or a Fresnel surface etc. In the method of manufacturing the hybrid lens, the transparent plastic material may be chemosetting plastic, thermosetting plastic or ultraviolet-curing plastic and so on. Such modifications and variations that may be apparent to those skilled in the art are intended to be included within the scope of this invention as defined by the accompanying claims.

What is claimed is:

1. A hybrid lens adapted for being assembled in a digital product, comprising:
a lens substrate made of glass material; and
a plastic layer formed and coating round the lens substrate, the plastic layer being made of transparent plastic material, a portion of the outer surfaces of the plastic layer being defined as a datum face capable of assembling and positioning the hybrid lens in the digital product.

2. The hybrid lens as claimed in claim 1, wherein the plastic layer includes a first coating portion formed on an incidence surface of the lens substrate, a second coating portion formed on an emission surface of the lens substrate, and a third coating portion formed on the other outer surfaces of the lens substrate except the incidence surface and the emission surface and connected between the first coating portion and the second coating portion, the datum face is directly formed by the outer surface of the third coating portion.

3. The hybrid lens as claimed in claim 1, wherein the plastic layer includes two separated parts designated as a first plastic layer and a second plastic layer, the first plastic layer is formed on an incidence surface of the lens substrate, the second plastic layer is spaced from the first plastic layer and includes a first coating portion formed on an emission surface of the lens substrate and a second coating portion formed on the other outer surfaces of the lens substrate except the incidence surface and the emission surface, the second coating portion is positioned between the first plastic layer and the first coating portion and connected with the first coating portion, the datum face is directly formed by the outer surface of the second coating portion connected with the first coating portion.

4. The hybrid lens as claimed in claim 1, wherein incidence and emission surfaces of the hybrid lens are any one of or a combination of at least two selected from a plane, a spherical surface, an aspherical surface or a Fresnel surface.

5. A method of manufacturing a hybrid lens, comprising the steps of:
fastening a lens substrate in a shaping cavity of a corresponding shaping mold with a portion of the inside of the shaping cavity defined as a shaping datum;
pouring a predetermined amount of transparent plastic into the shaping cavity;
hardening the transparent plastic to form a plastic layer round the lens substrate, accordingly, forming a datum face on the plastic layer by means of the shaping datum; and
opening the shaping mold to obtain the hybrid lens.

6. The method as claimed in claim 5, wherein the shaping mold has two designated as a first shaping mold and a second shaping mold, the first shaping mold opens a first shaping cavity thereon and the second shaping mold opens a second shaping cavity thereon, the shaping datum is formed by a portion of the inside of at least one selected from the first shaping cavity and the second shaping cavity.

7. The method as claimed in claim 6, wherein the first shaping mold and the second shaping mold are mated with each other and the first shaping cavity communicates and is mated with the second shaping cavity so as to once mold the plastic layer of the hybrid lens, the inside of the first shaping cavity protrudes to form a plurality of first fixing portions and the inside of the second shaping cavity protrudes to form a plurality of second fixing portions, the lens substrate is fastened by the fixing portions.

8. The method as claimed in claim 5, wherein the transparent plastic material is chemosetting plastic, thermosetting plastic or ultraviolet-curing plastic.
